(19) United States
(12) Patent Application Publication
(10) Pub. No.: US 2013/0151344 A1
(43) Pub. Date: Jun. 13, 2013

(54) SYSTEM AND METHOD FOR STORING AND ACCESSING ELECTRONIC RECEIPTS

(71) Applicants: Silvio Tavares, NE Atlanta, GA (US); Mark D. Baumgart, Larkspur, CO (US); Javier M. Alvarado, West Palm Beach, FL (US)

(72) Inventors: Silvio Tavares, NE Atlanta, GA (US); Mark D. Baumgart, Larkspur, CO (US); Javier M. Alvarado, West Palm Beach, FL (US)

(73) Assignee: FIRST DATA CORPORATION, Greenwood Village, CO (US)

(21) Appl. No.: 13/490,226

(22) Filed: Jun. 6, 2012

Related U.S. Application Data
(63) Continuation-in-part of application No. 13/314,988, filed on Dec. 8, 2011, now Pat. No. 8,306,846.
(60) Provisional application No. 61/625,519, filed on Apr. 17, 2012.

(51) Int. Cl. G06Q 20/20; G06Q 30/02

(52) U.S. Cl. 705/14.65; 705/16; 705/17; 705/24

(57) ABSTRACT

Electronic receipts arising from transactions processed at a card transaction processing system are captured and stored at the processing system for subsequent access by merchants and cardholders. Advertisements and promotional offers may be placed on the electronic receipts for viewing by a cardholder when the receipts are accessed.

### CROSS-REFERENCE TO RELATED APPLICATION

This application is a continuation-in-part of application Ser. No. 13/314,988 filed Dec. 8, 2011, and also claims the benefit of Provisional Application No. 61/625519, filed Apr. 17, 2012, both of which are hereby incorporated by reference.

### BACKGROUND OF THE INVENTION

Many consumers today prefer to minimize the amount of paper they receive when conducting a transaction. However, receipts are sometimes used by either a merchant or consumer to confirm or verify a transaction. The need has arisen for receipts to be conveniently generated and then made accessible to a merchant and consumer, without generating a paper receipt at the time of the transaction.

### BRIEF SUMMARY OF THE INVENTION

There is provided, in accordance with embodiments of the present invention, a network/system and method for storing and accessing electronic receipts, and for enrolling a card and/or cardholder for receiving such receipts.

In one embodiment, a method for managing receipts for card transactions conducted by a customer entity at a merchant comprises capturing transaction data by a card processing system at the time of a card transaction, generating electronic receipts by the card processing system from the transaction data, storing the electronic receipts at a database, and providing access to the stored electronic receipts to both the customer and the merchant.

In another embodiment, there is provided a method for managing electronic receipts comprising enrolling customers in a customer program for receiving electronic receipts in lieu of paper receipts for transactions conducted at merchants by customers using presentation instruments, wherein the presentation instruments are issued by a plurality of issuers, wherein enrollment is managed by a third party that is not a merchant and not an issuer of the presentation instruments, wherein enrollment includes storing, in a preference database managed by the third party, preference data from each of the customers, and wherein the preference data for each customer represents at least one customer preference regarding the transmission of a transaction notification at the time of a transaction. The method further comprises capturing, with a POS device, transaction data for each of the transactions, transmitting the transaction data to a transaction processing system, generating electronic receipts from the transaction data transmitted to the transaction processing system, storing the electronic receipts at a receipt database, and providing access to the stored electronic receipts to both the customers and the merchants.

A more complete understanding of the present invention may be derived by referring to the detailed description of the invention and to the claims, when considered in connection with the Figures.

### BRIEF DESCRIPTION OF THE DRAWINGS

FIG. 1 is a general block diagram showing a network in which transactions are conducted and electronic receipts generated in accordance with an embodiment of the invention.

FIG. 2 is a flow diagram illustrating a process in accordance with an embodiment of the invention, implemented in the network seen in FIG. 1.

FIG. 3 illustrates a text message confirming a transaction in lieu of a paper receipt, as seen on the display of a mobile device.

FIG. 4 illustrates an electronic receipt stored and accessed in the network of FIG. 1.

FIG. 5 is a block diagram illustrating a market analysis system for use in the network seen in FIG. 1.

FIG. 6 is a flow diagram illustrating an exemplary process for analyzing transaction data and generating promotional or coupon data.

FIG. 7 is an illustration of an exemplary market trend report resulting from analysis of transaction data by the market analysis system seen in FIG. 5.

FIG. 8 is a flow diagram illustrating an exemplary process at the transaction processing system seen in FIG. 1, for selectively suppressing the printing of receipts at POS devices.

FIG. 9 is a simplified illustration of a message sent by the transaction processing system in response to the processing of a transaction.

FIG. 10 is a block diagram illustrating an exemplary computer system upon which embodiments of the present invention may be implemented.

### DETAILED DESCRIPTION OF THE INVENTION

There are various embodiments and configurations for implementing the present invention. Generally, embodiments provide systems and methods for enrolling a card holder and/or a merchant for receiving electronic receipts (in lieu of paper receipts) and for capturing and storing electronic receipts so that they may be accessed by customers and merchants.

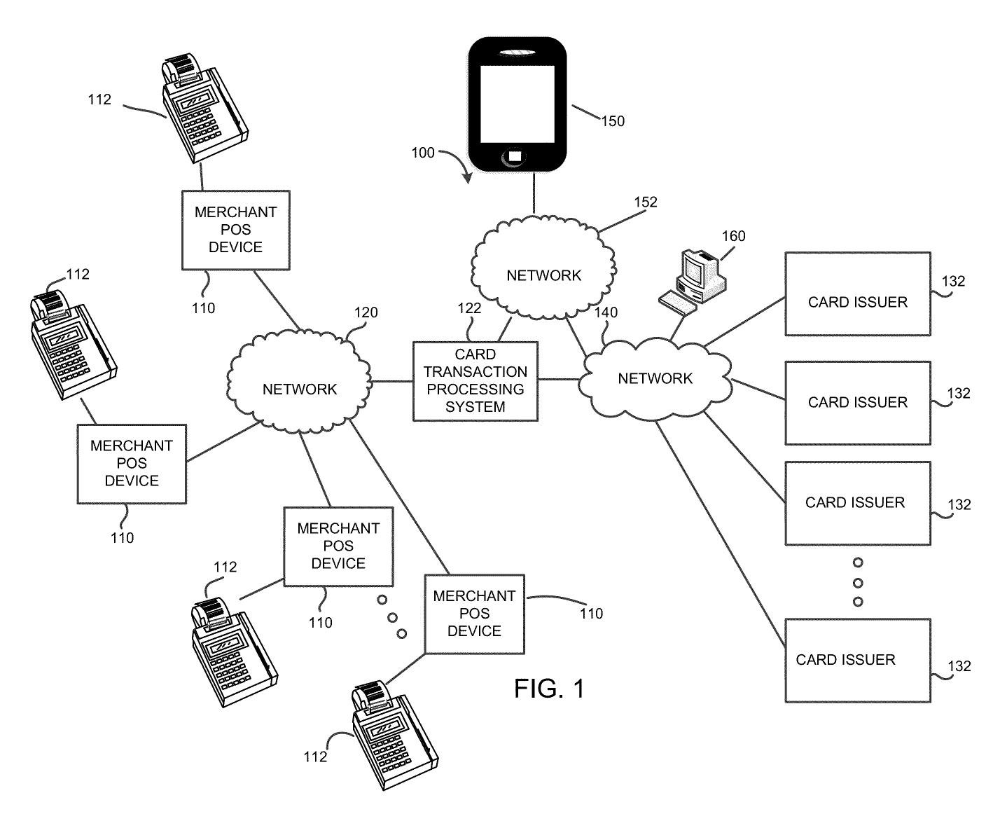

Referring to FIG. 1, a network 100 according to one embodiment of the invention is illustrated. In the network 100, a plurality of merchant POS terminals or devices 110 are connected through a network 120 to a card transaction processing system 122. The network 120 may be any one or more of various well known networks, e.g., a public network (such as the internet) for connecting POS devices from a plurality of different merchants to the transaction processing system 122, a private merchant network connecting POS devices operated by one merchant or one merchant chain to system 122, or a combination of public and private networks.

An input/output device 112 maybe associated with each POS device 110. For example, the device 112 may include a card reader for reading or entering information from a card used by a consumer/cardholder when conducting a transaction at the merchant, and a printer for printing receipts, such as a receipt copy to be taken by a consumer and a receipt copy to be kept by the merchant. As will be more fully discussed later, the printing of a receipt may be suppressed for certain transactions, so that a printed receipt is not produced at device 112.

The system 122 is connected through a network 140 to a plurality of card issuers 132 (banks or other entities that issue cards to consumers). The system 122 processes card transactions conducted at merchants and, in one embodiment, is operated by a third party card processing entity (an entity other than the merchant or the card issuer). The system 122 receives transaction information (including a card account number and other information on the transaction, such as amount, merchant identifier, etc.) entered or received at the POS device 110, and approves/declines the transaction (e.g., based on whether there is a valid card account and an acceptable transaction or amount). The approval of the transaction may be done directly by the processing entity (if it has authority from the issuer to do so) or may be done by the issuer of the card (through the network 140). If approved, the processing entity then completes the transaction for the customer and merchant. Also, in response to completing the transaction, the processing entity reconciles the transaction, by crediting the merchant and debiting the issuer for the transaction amount (this might be done in real time immediately upon transaction completion, or later in batch mode, e.g., at the end of each business day). While not shown, the transaction processing system 122 may also be connected to banks or other financial institutions maintaining accounts for merchants and issuers, for purposes of crediting a merchant's account and debiting an issuer's account based on the transaction amount, less any processing fees, e.g., fees charged by the card transaction processing entity or by a card association (e.g., VISA, MasterCard, and American Express). The system 122 as thus far described is known, and is similar to those operated by various transaction processing entities, such as First Data Corporation, Atlanta Ga.

Also illustrated in FIG. 1 is a mobile device 150 connected to the transaction processing system 122 through a network 152. The network 152 may include a wireless network for communicating with the mobile device 150. In one embodiment, if a consumer has agreed to electronic receipts for transactions (which will be determined by the system 122 when receiving the card account number as part of transaction information), the receipt (or data from the receipt in the form of a transaction notification or confirmation) is transmitted for display and review by a consumer at the mobile device 150, in lieu of the receipt being printed and provided to the consumer at the POS device 110. Alternatively, the consumer may receive transaction notifications and access electronic receipts at a different user device, such as a desktop personal computer or similar device 160. While the network 152 is shown connected directly to the system 122 (for transmitting a transaction notification), it should be appreciated that the transmission of transaction information to mobile devices (or other user devices) may be done through the issuer, through the merchant, or through another entity having access to the transaction information.

In one embodiment, only an SMS text transaction notification (with basic transaction information, such as date, amount and merchant name) is sent to the consumer at mobile device 150 at the time of the transaction, with access to the full receipt available to the consumer (or the merchant) at a website operated by the issuer (or operated by the card transaction processor). The mobile device (or email address) for receiving the transaction notification can be provided as a preference by the consumer during enrollment. In an alternative embodiment, a full receipt (in addition to or in lieu of a transaction notification) may be sent at the time of the transaction to a consumer at an email address provided as a preference during enrollment.

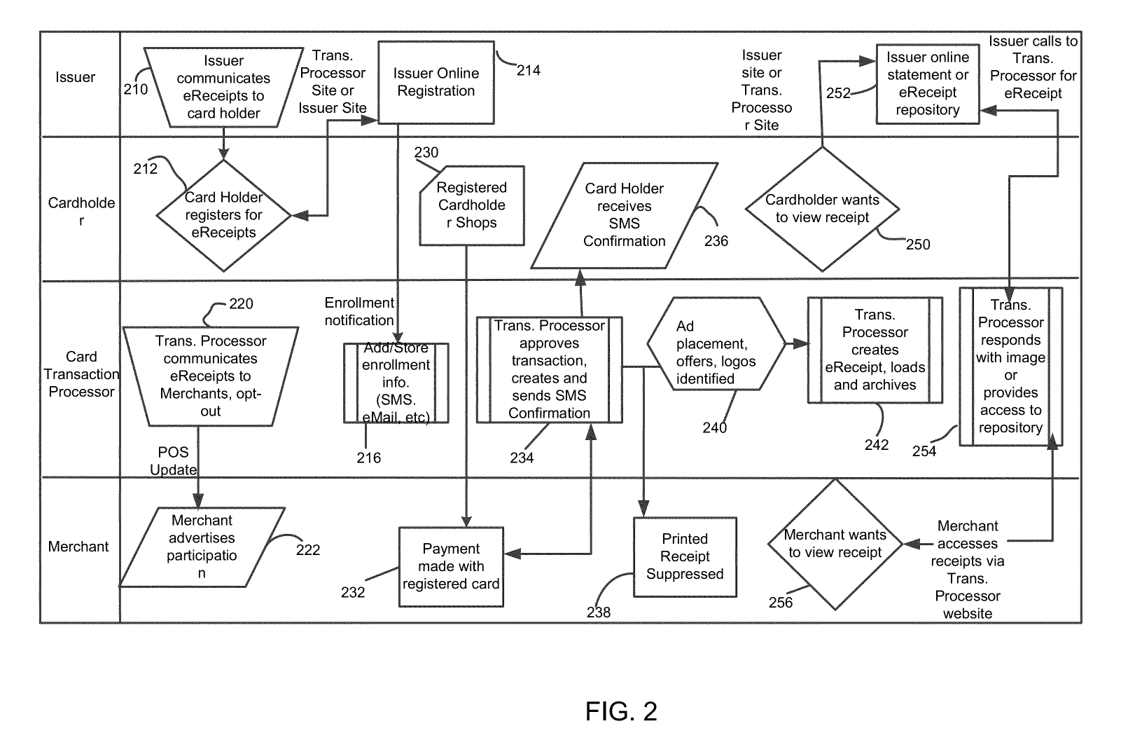

Turning to FIG. 2, there is illustrated a process for implementing one embodiment of the invention. The various steps of the process are arranged to reflect the party involved in each step, namely, the merchant, the card transaction processor (the entity operating the system 122), the cardholder (consumer), and the issuer of the card. In the process of FIG. 2, it is contemplated the card transaction processor is the party managing the overall process for generating electronic receipts (eReceipts) and the subsequent access of such receipts by a cardholder or a merchant. This may be conveniently done by card transaction processor since, in the described embodiment, the card transaction processor captures, has access to, and coordinates the flow of transaction information between the merchant and the issuer, and would have access to cardholder preferences (e.g., text or email), and such preferences would not need to be requested from the cardholder at the time of the transaction. However, another entity could be part of the network 100 to receive transaction data or electronic receipts and to perform those functions.

Another advantage to the embodiment of FIG. 2 is eliminating the need for multiple entities collecting data and preferences as part of enrolling cardholders. Past electronic receipt programs have typically been managed by either individual merchants or issuers. However, if managed by a merchant, then the cardholder would have to provide enrollment preferences (such as mobile numbers and/or email addresses) to each merchant, and the electronic receipts would be issued only for those merchants with whom a cardholder has enrolled. On the other hand, if managed solely by a card issuer, then the issuer could provide access to electronic receipts to cardholders (e.g., a duplicate for a receipt that may have been printed at a merchant), but merchants themselves would not know in any given instance whether a cardholder desires a printed receipt or not. In the embodiment of FIG. 2, the card transaction processor has a relationship with each of the merchants in its network (by virtue of processing those merchants' transactions). Thus, by the card transaction processor enrolling the cardholder, either directly or through an issuer (if through an issuer, then the issuer provides enrollment information and preferences to the card transaction processor), the card transaction processor can manage the issuance of electronic receipts (and the suppression of printed receipts) for any merchant for whom it processes transactions.

Returning to FIG. 2, at step 210 the issuer (or another entity on behalf of the issuer) communicates to the cardholder regarding the availability of electronic receipts, and at step 212 a cardholder wishing to receive electronic receipts registers/enrolls a card (or multiple cards of the cardholder) with the issuer for such purpose. In one embodiment, registration is done (e.g. using personal computer 160) through a website of the issuer, but alternatively it could be done at a website of the card transaction processor (e.g., in one embodiment, a website operated by the card transaction processor but branded with the name and logo of the issuer), or through a different means (e.g., over the phone with a representative of the issuer or with the use of an interactive voice response system). The registration is completed with the issuer at step 214, and information provided during the registration and needed to implement electronic receipts (e.g., a mobile device ID or number, an email address of the cardholder, and other cardholder preferences) is provided to and stored by the card transaction processor at step 216 (e.g., at a preference repository/database within the transaction processing system 122). It should be appreciated that various options for receiving electronic receipts may be selected by the cardholder during registration. For example, the cardholder might elect to receive electronic notifications (confirmations or alerts) when a transaction is being conducted via SMS (short message service) text messages, emails, or both. The cardholder might also elect to receive emails with a complete image copy of each electronic receipt after a transaction (e.g., in addition to having access to all the receipts made available to the cardholder at a website). The cardholder might also elect to receive a paper receipt in addition to an electronic receipt in either all transactions or certain types of transactions (e.g., any transaction over a specified dollar amount).

The card transaction processor separately communicates the availability of electronic receipts to the merchant at step 220. The merchant may choose to either to use electronic receipts or to opt out of doing so at step 220, but if the merchant elects to use electronic receipts, that fact may be advertised or communicated by the merchant to cardholders (e.g., with a display at the POS device 110) at step 222. It would generally be seen as advantageous for the merchant to promote and encourage the use electronic receipts in lieu of paper receipts (e.g., potential savings to the merchant from needing less time to complete the transaction and from the reduction in cost of paper). However, it should be appreciated that even if the merchant elects to use electronic receipts, the merchant would still need to provide paper receipts to cardholders that do not want to use electronic receipts (e.g., the cardholder has not enrolled) or that may request to receive paper receipts in certain transactions (such as large dollar amount purchases).

While not illustrated in FIG. 2, the merchant may also provide preferences to the card transaction processor if electing to use electronic receipts. For example, the merchant might provide an email address for receiving notifications or communications from the card transaction processor regarding electronic receipts (e.g., emails with links used to access individual receipts, aggregated receipt data, or status/balances pertaining to the merchant's account). Further, the merchant might also provide preferences regarding the appearance or content of the electronic receipts (merchant name, logo and other information to appear on the receipt). In addition, the merchant might provide information to manage any merchant coupon that might appear on the receipts, e.g., an image or graphic for the coupon, a merchant website link, a social networking site link (e.g., Facebook or Twitter sites) for the customer to post comments, or a date range or other parameters (e.g., transaction amount or transaction type) controlling whether or not a merchant coupon would appear on any given electronic receipt.

At step 230, the cardholder shops at a merchant and, at step 232, makes payment with a card that has been registered/enrolled for receiving electronic receipts. At step 234, if the transaction is approved by the card transaction processor (e.g., after verifying the card number and amount with the issuer), and the cardholder is identified as having elected electronic receipts (such as through look-up at the system 122), then the card transaction processor sends an SMS (text) confirmation of the transaction to the cardholder, typically at the time of the transactions so that the cardholder can receive the SMS confirmation (step 236) and confirm the transaction and the transaction amount on the cardholder's mobile device. At the same time as the SMS confirmation is sent, the card transaction processor also sends (step 238) a message to the POS device (at which the transaction has been conducted), suppressing the printing of the paper receipt. The SMS confirmation and the suppression of the printing of the receipt will usually occur simultaneously (or nearly simultaneously), and a message to the merchant regarding approval of the transaction (typically causing an “approval” indication to be displayed at the POS device) can include a command (e.g., a marker bit in the approval message) instructing the printer not to print the receipt (and in one embodiment causing the approval displayed at the POS device to also include an indication that no receipt will be printed).

In some embodiments, the SMS confirmation message may include an accept button to be actuated or clicked by the cardholder at the mobile device (acknowledging or accepting the transaction). In such case, the transaction would be completed by the card transaction processing system only after the transaction is accepted by from the cardholder. In other embodiments, the merchant could elect (e.g., as part of its provided preferences) to have a second SMS text message sent immediately after the SMS confirmation or transaction notification, which might provide a button or link for the cardholder to use immediately after the transaction for various purposes, e.g., to provide immediate feedback to the merchant on the transaction (was the cardholder satisfied with the merchant location, with the merchant sales clerk, with the general shopping experience, etc.), or a button or link to access a social networking site to post a comment about the transaction or the product purchased (e.g., “I just purchased a great sweater at merchant X”).

At step 240, the card transaction processor then determines advertisements, offers and logos that should be included in (1) the electronic receipt (these will be described later in conjunction with FIG. 4) or (2) the SMS confirmation, or (3) both the electronic receipt and the SMS confirmation. The card transaction processor then creates the electronic receipt (with the transaction data as well as desired logos and advertising) and stores it (at a receipt repository/database in system 122) for subsequent access by either the merchant or the cardholder (step 242). In some instances, the card transaction processor may provide the electronic receipt to the issuer (along with other electronic receipts for other transactions involving that issuer) so that access by the cardholder can be made through the issuer. Also, while steps 240 and 242 provide for the created electronic receipt to include advertisements, in some embodiments any advertisement may be held in suspense (and not created or placed on the receipt) until the cardholder actually accesses the electronic receipt (thus providing an advertisement more appropriate for the time that it is actually seen on the receipt by the cardholder).

At step 250, a cardholder requests to view an electronic receipt. In some instances, this may occur shortly after the SMS confirmation is sent to the cardholder. While the SMS confirmation may include basic transaction data (date, amount, merchant), the cardholder may want to see more details of the transaction (e.g., an image similar to the traditional paper receipt and perhaps including an electronically captured cardholder signature), and can request it at the time of the SMS confirmation. In other instances, a cardholder may request to view a receipt later, e.g., when a monthly statement is received. For example, an on-line monthly statement might include, for each transaction item on the statement, a hypertext link for viewing the receipt, and the cardholder uses that link to access the electronic receipt (e.g., using personal computer 160).

Thus, at step 252, the issuer may provide a website that is accessed via links on the on-line statement or using the SMS confirmation message, which causes a request to the card transaction processor (or the issuer) to provide the receipt. If the receipt is stored at the system 122, the card transaction processor responds with an image of the receipt at step 254.

The merchant can also request access to a receipt, e.g., if a customer disputes a transaction amount, at step 256. The card transaction processor will provide an image or provide access to its database at step 254 for purposes of responding to a merchant request.

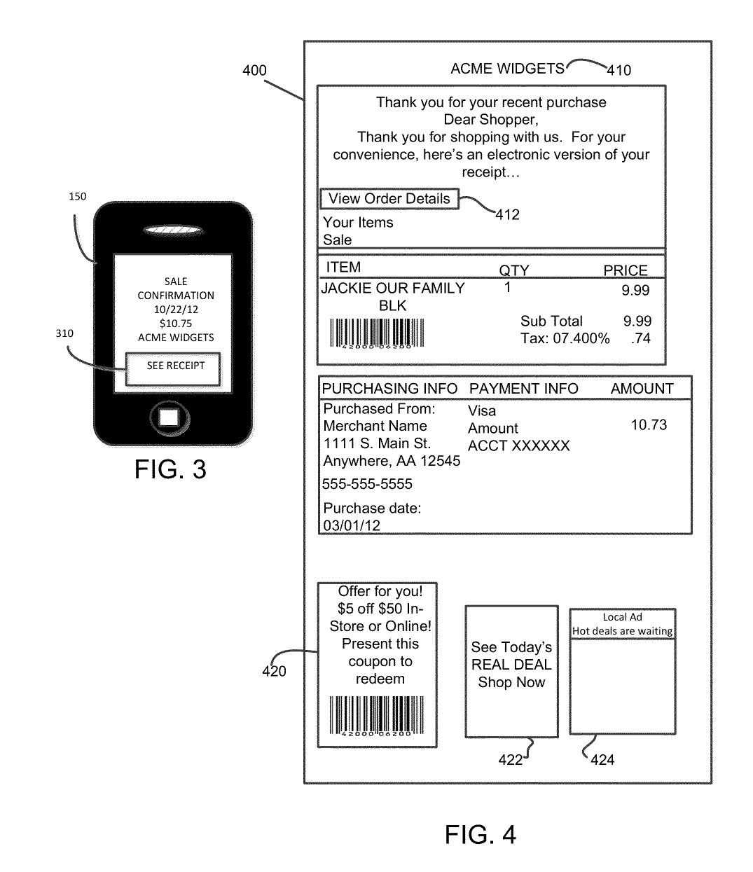

FIG. 3 illustrates one of the mobile devices 150 with an SMS confirmation message to a cardholder in response to a transaction being conducted (step 236 in FIG. 2). As seen, the confirmation includes basic information on the transaction, such as the date, the amount, and the name of the merchant. The message might also include a button 310 for the cardholder to select in order to see the complete receipt, if desired. If the button is selected, the receipt is retrieved (e.g., from the transaction processor at step 254 in FIG. 2). As mentioned earlier, in some embodiments an additional button may appear in the SMS confirmation (not shown in FIG. 3) for the cardholder to select in order to accept or acknowledge the transaction.

FIG. 4 illustrates an electronic receipt 400 as might be seen by a cardholder after requesting access to the receipt. The receipt 400 may not only be viewed by the cardholder (e.g., a display device at the personal computer 160), but also a copy may printed if desired (e.g., a printer at the personal computer 160). The receipt includes transaction information similar to what would appear on a traditional paper receipt (e.g. the date, the amount, and the name of the merchant, and such additional information as specified by the merchant). It should be appreciated that the receipt would have information to evidence the transaction and provide proof of the transaction (e.g., as would be accepted by the merchant if a purchased item is to be returned and a refund made). A button 412 could be selected by the cardholder to see details of the transaction (e.g., data that might normally be available only from the merchant, such as product size or grade, details of the product being purchased, and so forth). While that further data could be provided by the merchant and stored with the receipt by the card transaction processor at system 122, the button 412 might also be used to access a different website (e.g., one operated by the merchant) where more detailed information on the merchant product (or merchant service) might be stored.

As seen in FIG. 4, the electronic receipt 400 includes a logo or other branding information 410 pertaining to the merchant, as well as different forms of promotions or advertising. For example, as indicated at 420, the merchant conducting the transaction may request placement of a coupon or advertisement pertaining to that merchant. As indicated at 422, a separate advertisement may be placed on the receipt based on information collected or identified from aggregated transaction data processed by the card transaction processor (to be described in greater detail later). Generally, the card transaction processor might consider a plurality of transactions conducted by the cardholder of the current transaction (in one embodiment, the transactions might be conducted at a plurality of different merchants or might involve cards from a plurality of different issuers), and determine certain spending habits or preferences of the current cardholder. As one brief example, the cardholder might be determined (based on analysis of many of the cardholder's transactions) to be a frequent customer of restaurants (or certain types of restaurants), and a specific promotional offer pertaining to restaurants might be placed on the receipt, based on a determination that such an offer will likely be of interest to the cardholder.

Also seen in FIG. 4 is a general advertisement 424 that is not specific to the merchant or the cardholder in the transaction at hand, but rather one that is made generally available to all cardholders or to all cardholders in a certain category (e.g., all cardholders in a specified geographical area). A merchant (not necessarily the merchant involved in the transaction) could purchase advertising space on receipts of cardholders (or a category of cardholders) in order to promote its products or services.

In one embodiment, the advertisements 420, 422 and 424 are placed on the receipts for viewing by the cardholder, but are removed (automatically or selectively, by a merchant) when a receipt is viewed by the merchant.

As should be appreciated, the availability of electronic receipts and the transmission of a transaction confirmation (particularly as combined with analysis of data associated with the aggregated transactions) gives rise to various general and targeted advertising opportunities, and potential revenue for the card transaction processor, as part of providing access to electronic receipts.

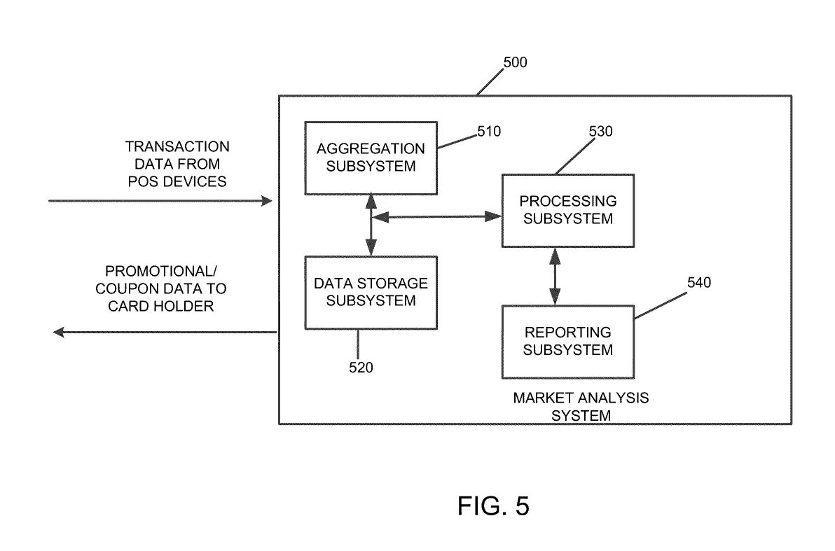

A more detailed description will now be provided for embodiments in which data from transactions can be aggregated and then analyzed to provide targeted promotional information to a cardholder. In one embodiment, as illustrated in FIG. 5, a market analysis system 500 may be employed develop marketing information. The system 500 may be conveniently connected for receiving transaction data via the transaction processing system 122 and, after analysis, providing promotional or coupon data to cardholders via the transaction processing system 122. In other embodiments, the system 500 may be part of the transaction processing system 122 or separately operated by the card transaction processor. The system 500 develops marketing information by aggregating transaction data (generated for transactions at the POS devices 110) and then analyzing the transaction data to identify customer or transaction patterns and trends, and in turn provide promotional or coupon data to the card transaction processor, that is then sent in turn to a cardholder, e.g., as part of a transaction notification that is displayed on a mobile device (such as the transaction notification seen in in FIG. 3) or as part of an electronic receipt (such as the electronic receipt seen in FIG. 4). In some cases, spending patterns may be determined from transactions conducted by a specific cardholder, resulting in an advertisement such as the advertisement 422 targeted to a specific cardholder as described earlier. In other cases, the patterns may relate to transactions conducted by a much larger population of cardholders (and their transactions), as will be described shortly.

The system 500 is seen in FIG. 5 to include an aggregation subsystem 510, a data storage subsystem 520 and a processing subsystem 530. In some embodiments, transaction data (originating from the POS devices 112) is provided to the aggregation subsystem 510 using standard formats and/or protocols. In other embodiments, the aggregation subsystem 510 is configured to process (e.g., parse) the data into a usable and/or desired format. The data may then be stored in the data storage subsystem 520 as aggregated transaction data. In some embodiments, the aggregated transaction data is a collection of data from a large number of transactions (say, hundreds of thousands or even millions of transactions), with the processing subsystem 530 mining the aggregated data for information relating to patterns in transactions for specific cardholders and, in other cases, mining the data for information relating to patterns across many transactions by many different cardholders. It is worth noting that the aggregated transaction data ultimately stored in data storage subsystem 520 may be arranged in any useful way, for example, as an associative database, as a flat file, as sets of transaction data, in encrypted or unencrypted form, in compressed or uncompressed form, etc.

The result of processing subsystem 530 analyzing the aggregated transaction data is marketing data that may be used of various purposes, such as marketing reports to merchants and others, and generating adverting, coupons or other promotional data. In one embodiment, the marketing data may be reported to the card transaction processor, to merchants or to others through a reporting subsystem 540 for analysis and marketing action based on the reported data. In other embodiments, the processing subsystem 530 may develop advertising or coupons based on the marketing data (in conjunction with marketing analysis, product information or other input from merchants), and apply the marketing data and the developed advertising or coupons in real time to individual transactions as they are being processed at the card transaction processing system 122.

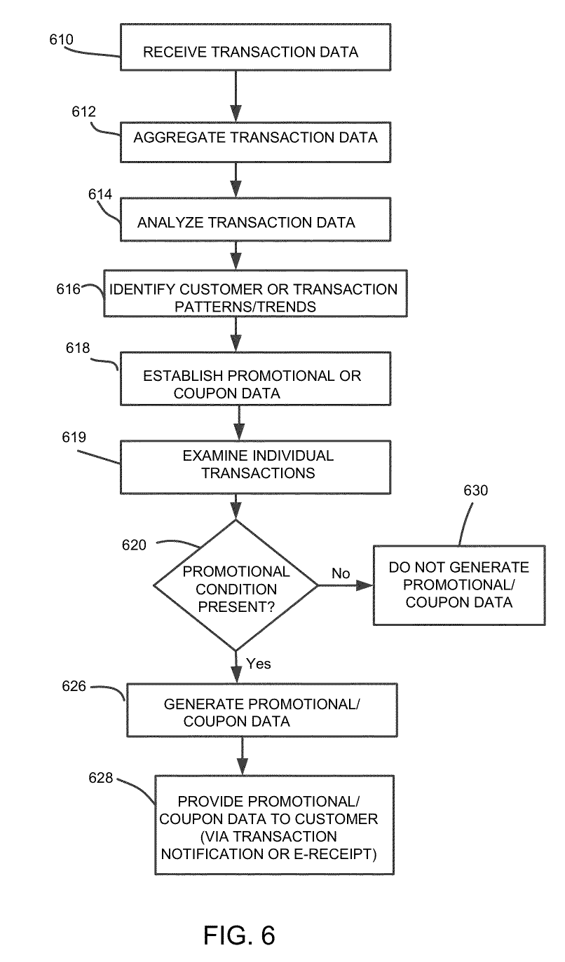

FIG. 6 is a flow diagram of one exemplary process carried out by the market analysis system 500. At step 610, transaction data (captured at the POS devices 110) is received at the system 500, such as through the card transaction processing system 122. At step 612, the transaction data is aggregated by aggregating subsystem 510 and stored in the data storage subsystem 520. The aggregated data is analyzed by the processing subsystem 530 at step 614, and resulting marketing data (e.g., customer or transaction patterns or trends) is identified at step 616. The system 500 establishes advertising or coupon data at step 618, based on the identified patterns or trends and, where appropriate, input from a merchant or prospective advertiser.

While the transaction data aggregated and analyzed steps 612 and 614 may be associated with many different types of information, some typical types of information can be classified into two general categories: specific transaction data and terminal data. Specific transaction data may include, as an example, information identifying a specific product purchased (including attributes of the product, such as size, quantity or amount) and its purchase price. Terminal data may include information relating to (e.g., identifiers corresponding to) a merchant and/or a merchant chain where the POS device 110 is located, network information (e.g., Internet protocol (IP) address, security protocols, etc.), configuration information (e.g., types of payment instruments accepted, software version, etc.), and/or any other information relating to the POS device 110 and not specific to any transaction conducted via the POS device 110.

It is worth noting that terminal data may indicate characteristics of the POS device 110 in various ways. For example, various types of merchant classifiers may be used. In one embodiment, a merchant classifier code (MCC) defined by a government standard is used to identify each merchant. In other embodiments, a proprietary code may be used. Further, in some embodiments, each merchant is identified by a single classifier, even where the merchant operates in multiple markets. For example, a megastore may sell groceries, general merchandise, gasoline, insurance services, etc., but the merchant may be classified only using a “grocery” classification or a “discount department store” classification. In an alternate embodiment, the megastore may be classified using multiple classifiers. In still another embodiment, the megastore may be classified by both a single classifier (e.g., a default classifier, or a classifier chosen to comply with a particular standard) and by one or more other classifiers (e.g., according to proprietary classification systems).

Specific transaction data, on the other hand, may include any type of information relating to one or more transactions conducted via the POS device 110. For example, the specific transaction data may include (beyond the example given earlier) timestamp information (e.g., a date and time, or time range, of one or more transactions), transaction value, fee and/or discount information, product category and/or description information, demographic information (e.g., relating to the payor), etc.

The specific transaction data that is collected by POS device 110 may depend on the particular payment instrument used to make a payment. For example, when paying by credit or debit card, the track two data is typically read using a magnetic stripe reader. Also, the amount of the purchase is entered, typically electronically at the POS device 110. For traditional credit cards, the account number is typically read from the magnetic stripe, and the amount of the transaction is received by manual key in or by reading a product bar code and using a look-up table.

Not all the transaction data received at the POS devices 110 may be needed in order to generate the marketing data. As such, a parsing processes may be used to extract only the relevant data needed to produce the data. This parsing can occur at various locations including, but not limited to, a system at the network 120, the card transaction processing system 122, the aggregation subsystem 510, or elsewhere.

In some cases, a type of mapping may be used in order to be useful for a given market, such as trends by industry, geography, card type and the like. For instance, data from the POS device 110 may reveal the identity of a given merchant. This merchant may then be classified into a specific industry, such as fast food, so that a trend report may be produced by industry. A similar approach can be used when determining trends by geography, such as by knowing the zip code of the merchant or other geographic identifier originally gleaned from the POS terminal. For card types, the transaction data can be evaluated to determine what payment instrument was used in the transaction.

Given these and/or other types of aggregated transaction data, resulting marketing data may include extracted or classified data, such as data extracted for a particular time period, data extracted for all records having the same store identifier, data classified by merchant type, data classified by location (e.g., merchant region, geographic region, etc.), data classified by dollar volume, data classified by average ticket price, etc. The marketing data may additionally or alternately include trend data, such as data trends over a particular time period or compared to a baseline. The trends may look at time periods, payment types, merchants, merchant categories, geography, transaction volumes, ticket values, or any other useful (e.g., and derivable) characteristics of the aggregated transaction data.

Previously referenced U.S. application Ser. No. 13/314,988 discloses various techniques, processes and systems for aggregating and analyzing transaction data, any of which could be used herein.

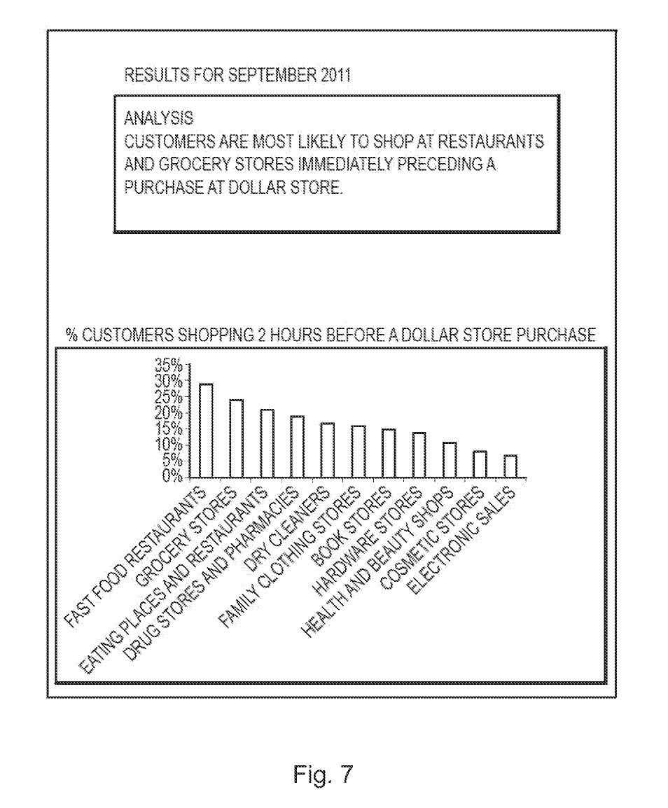

In one specific example illustrated in FIG. 6, the processing system 530 may determine (at step 616) that cardholders conducting a certain type of transaction with a specified merchant category (say, fast food restaurants or grocery stores) have a significant likelihood of making a purchase within 2 hours at a discount store (this spending pattern is illustrated by a sample report shown in FIG. 7). Based on this trend or pattern, the processing subsystem 530 may establish a promotional or coupon data for the identified trend (e.g., a coupon for a discount store for any customer having just made a fast food or grocery purchase). The system 500 then examines individual transactions at step 619. The system identifies at step 620 whether or not an individual transaction (i.e., an individual transaction represented in the transaction data provided on a real time basis from the card transaction processor to the system 500) has the promotional condition to which the promotional or coupon data might apply. Continuing with the specific example mentioned earlier, the individual transaction in this example could be a cardholder making a purchase at a fast food restaurant or a grocery store. If such condition (a purchase at a fast food restaurant or grocery store) is found to exist at step 620 in the current transaction, then advertising or coupon data for the condition (in this example, an advertisement or coupon for a discount store) is generated at step 626, and such data is returned to the card transaction processor and in turn provided to a customer as part of a transaction notification or an electronic receipt for that transaction, step 628. As should be appreciated, the promotional data being generated in real time (step 626), while a transaction is being processed at the transaction processing system 122, results in promotional data that is relevant to a customer, having a higher likelihood that the customer will in fact be interested in the promotional data. If a given transaction does not meet the condition specified at step 620, then the promotional or coupon data is not generated (step 630).

It should be appreciated from the forgoing description that the process in FIG. 6 thus encompasses both (1) aggregation of transaction data from many transactions and analysis of the aggregated data (steps 612-616), and (2) analysis of individual transactions and the real time generation of promotional data for those individual transactions based on marketing data resulting from the analysis of the aggregated data. In some cases, the analysis of aggregated data and the separate analysis of individual transactions may occur simultaneously (and in real time). In other cases, the analysis of aggregated data may occur first, and then the results of that analysis is later used in the analysis of individual transactions.

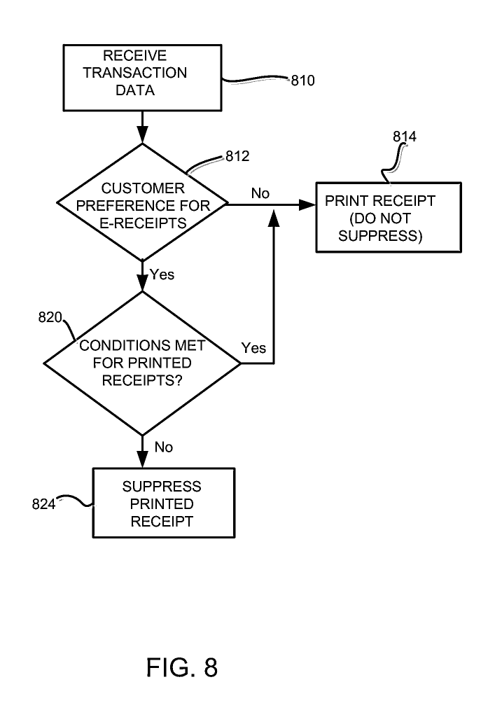

Turning now to FIG. 8, there is illustrated a more detailed exemplary process by which the transaction processing system 122 may either permit or suppress the printing of electronic receipts at the POS devices 110, briefly described earlier in conjunction with FIG. 2 (e.g., step 238). As should be appreciated, since the third party transaction processor is processing transactions data received from merchants, and since the transaction processor approves or rejects those transactions based on that processing, and since the transaction processor maintains or has access to data that reflects the preferences of cardholders (and merchants) as to receiving electronic receipts in lieu of paper receipts, the control of whether a printed receipt or electronic receipt is generated for the cardholder can be conveniently managed at the transaction processing system 122.

At step 810, transaction data for each transaction conducted by a customer at one of the POS devices 110 is received at the transaction processing system 122. In response to identification of the account at which the transaction is conducted, the transaction processing system 122 determines, step 812, whether the customer has enrolled (for that account) in a program for receiving electronic receipts and has provided preference information (for receiving electronic receipts) as part of the enrollment. If the customer has not enrolled (there are no such preferences), then at step 814 the printing of an electronic receipt is permitted (not suppressed) at the POS device 110, pursuant to a returned transaction response (approval/rejection) message by the transaction processing system 122.

If a customer has enrolled and established preferences at step 812, then the transaction processing system determines, at step 820, whether a condition has been established (by the customer during enrollment) and that condition has been met (for the current transaction) for the customer to receive printing receipts (even if an election has been made by the cardholder to generally receive electronic receipts). As mentioned earlier, one example of such a condition may be the amount of the transaction (e.g., printed receipts are to be received for any transaction over a specified transaction amount, such as $1000, even if the cardholder has otherwise enrolled for electronic receipts). If the transaction is above the specified transaction amount, then as part of the returned approval message to the POS device 110 from the transaction processing system 122, the system 122 permits the receipt to be printed (step 814). If the transaction amount is not above the specified transaction amount, then the system 122 suppresses the printing of the receipt when transmitting the approval message, step 824.

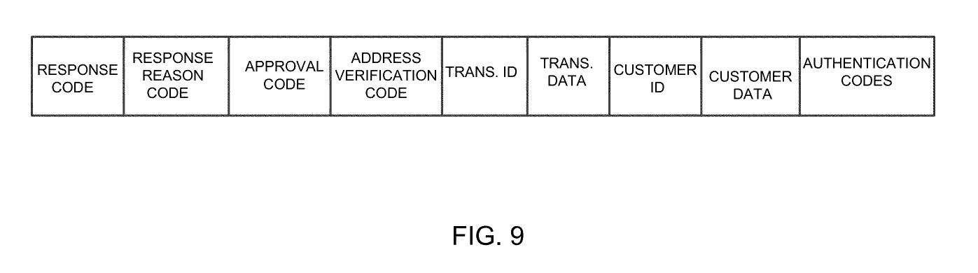

FIG. 9 depicts an exemplary response message from the transaction processing system 122 to a POS device 110 after a transaction has been processed, illustrating one embodiment of the suppression of receipt printing at one the POS devices 110. The message illustrated in FIG. 9 has data fields of a type that are well understood by those skilled in the. Such fields include:

Response Code—Indicates the results of processing the transaction at the transaction processing system 122, such as “approved,” “declined,” and “error” (erroneous data has been entered).

Response Reason Code—A code representing more details about the result of the transaction (e.g., a reason for a transaction being declined, such as amount invalid, credit card number invalid, credit card expired, etc.).

Approval Code—An alphanumeric authorization or approval code for an approved transaction.

Address Verification Code—A code indicating the results of the verification of a street address or zip code, if provided as part for the transaction data (e.g., match, no match, address unavailable, etc.).

Transaction ID—An identification number that has been assigned to the transaction in question.

Transaction Data—Data that replicates transaction data entered at the POS device where the transaction was conducted, such as transaction amount, transaction description, transaction type (credit card, debit card).

Customer ID—Data that replicates the customer/account ID entered at the POS device.

Customer Data—Customer data that has been retrieved at the transaction processing system and associated with the customer account, such as cardholder name, address, phone number, etc.

Authentication Codes—System generated hash codes used by the POS device to authenticate a response message and a response authentication code resulting from checking a Card Verification Code appearing on a card (if provided as part of the transaction).

While there are various embodiments and implementations for providing a code or marker bit for suppressing printing of a receipt at the POS device 112, in one embodiment the above referenced Response Reason Code could include two different approval reason codes in the case of approval, one indicating “approved—print receipt” and the other indicting “approved—do not print receipt.” Thus, referring to FIG. 8, when the “approved—print receipt” code is present in the approval reason code field, step 814 is carried out at the POS device. On the other hand, when the “approved—do not print receipt” code is present in the approval reason code field, step 824 is carried out at the POS device.

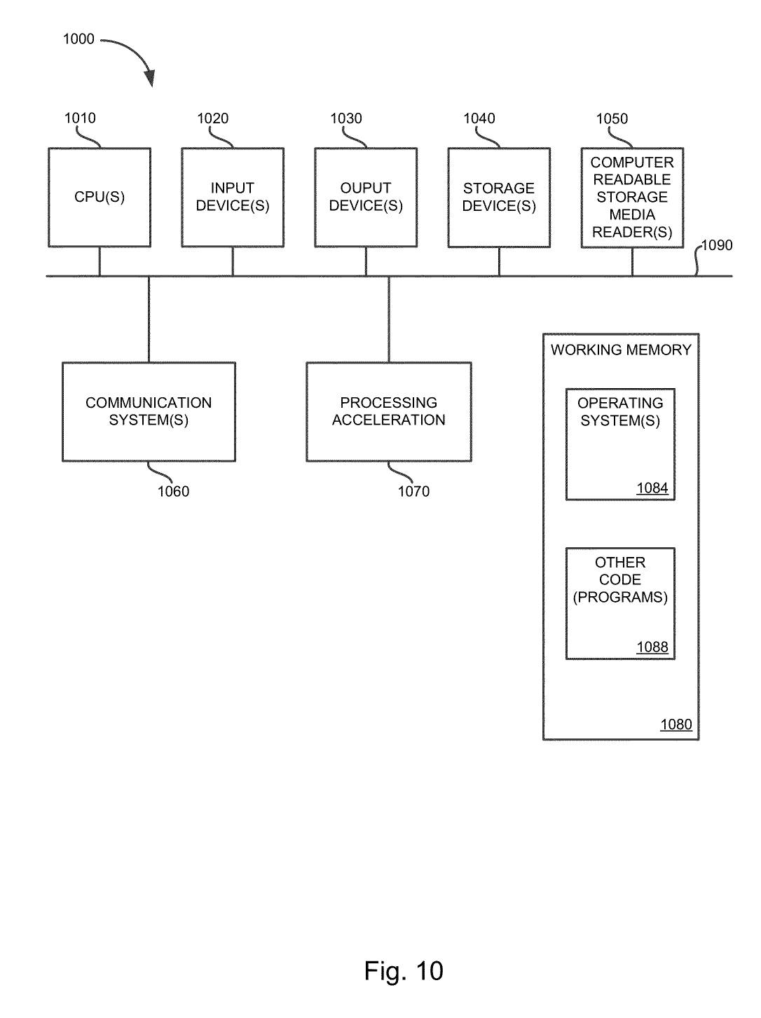

FIG. 10 is a block diagram illustrating an exemplary computer system upon which embodiments of the present invention may be implemented. This example illustrates a computer system 1000 such as may be used, in whole, in part, or with various modifications, to provide the functions of the POS devices 110, the card transaction processing system 122, and the market analysis system 500, as well as other components and functions of the invention described herein.

The computer system 1000 is shown comprising hardware elements that may be electrically coupled via a bus 1090. The hardware elements may include one or more central processing units 1010, one or more input devices 1020 (e.g., a mouse, a keyboard, etc.), and one or more output devices 1030 (e.g., a display device, a printer, etc.). The computer system 1000 may also include one or more storage devices 1040, representing remote, local, fixed, and/or removable storage devices and storage media for temporarily and/or more permanently containing computer-readable information, and one or more storage media reader(s) 1050 for accessing the storage device(s) 1040. By way of example, storage device(s) 1040 may be disk drives, optical storage devices, solid-state storage device such as a random access memory (“RAM”) and/or a read-only memory (“ROM”), which can be programmable, flash-updateable or the like.

The computer system 1000 may additionally include a communications system 1060 (e.g., a modem, a network card—wireless or wired, an infra-red communication device, a Bluetooth™ device, a near field communications (NFC) device, a cellular communication device, etc.) The communications system 1060 may permit data to be exchanged with a network, system, computer, mobile device and/or other component as described earlier. The system 1000 also includes working memory 1080, which may include RAM and ROM devices as described above. In some embodiments, the computer system 1000 may also include a processing acceleration unit 1070, which can include a digital signal processor, a special-purpose processor and/or the like.

The computer system 1000 may also comprise software elements, shown as being located within a working memory 1080, including an operating system 1084 and/or other code 1088. Software code 1088 may be used for implementing functions of various elements of the architecture as described herein. For example, software stored on and/or executed by a computer system, such as system 1000, can be used in implementing the processes seen in FIGS. 2, 6 and 8.

It should be appreciated that alternative embodiments of a computer system 1000 may have numerous variations from that described above. For example, customized hardware might also be used and/or particular elements might be implemented in hardware, software (including portable software, such as applets), or both. Furthermore, there may be connection to other computing devices such as network input/output and data acquisition devices (not shown).

While various methods and processes described herein may be described with respect to particular structural and/or functional components for ease of description, methods of the invention are not limited to any particular structural and/or functional architecture but instead can be implemented on any suitable hardware, firmware, and/or software configuration. Similarly, while various functionalities are ascribed to certain individual system components, unless the context dictates otherwise, this functionality can be distributed or combined among various other system components in accordance with different embodiments of the invention. As examples, the card transaction processing system 122 and the market analysis system 500 may be each implemented by a single system having one or more storage device and processing elements, or may be implemented by plural systems, with their respective functions distributed across different systems either in one location or across a plurality of linked locations. Further, while the POS device 110 and input/output devices 112 may be individual or standalone devices linked to network 120, they could be integrated into other merchant devices, systems and networks.

Moreover, while the various flows and processes described herein (e.g., those illustrated in FIGS. 2, 6 and 8) are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems.

Also, while the presentation instrument used for conducting transactions in the illustrated embodiment is a credit card, it should be appreciated that the invention is applicable to other forms of presentation instruments, such as debit cards, stored value cards, loyalty cards, gift cards, smart cards, and contactless cards or payment instruments (e.g., fobs and other devices that wirelessly transmit account information to a POS device when conducting a transaction). Thus, the term “card” is used herein for ease of description and is intended to refer to not only traditional financial cards, but rather to all forms of presentation instruments, including those just mentioned as examples. Further, the term “entity” is used herein in its broadest sense to include not only an organization but also an individual person.

Hence, while various embodiments may be described with (or without) certain features for ease of description and to illustrate exemplary features, the various components and/or features described herein with respect to a particular embodiment can be substituted, added, and/or subtracted to provide other embodiments, unless the context dictates otherwise. Consequently, although the invention has been described with respect to exemplary embodiments, it will be appreciated that the invention is intended to cover all modifications and equivalents within the scope of the following claims.

1. A method for managing electronic receipts for transactions conducted by customer entities at merchants using presentation instruments, the method comprising:
enrolling, by one or more processors, customer entities in a customer program for receiving electronic receipts in lieu of paper receipts for transactions conducted at merchants by customer entities using the presentation instruments, wherein the presentation instruments are issued by a plurality of different issuers, wherein enrollment is managed by a third party entity that processes transactions between merchants and customer entities using the presentation instruments, wherein the third party is not a merchant and not an issuer of the presentation instruments, wherein enrollment includes storing, in a preference database managed by the third party entity, preference data from each of the enrolled customer entities, and wherein the preference data for each enrolled customer entity represents at least one customer preference regarding the transmission of a transaction notification at the time of a transaction in lieu of a paper receipt, and wherein the preference data for at least one or more of the enrolled customer entities further represents a preference for printing of a receipt when a transaction is above a specified amount;
receiving, at a transaction processing system from a plurality of point-of-sale (POS) devices, transaction data for a plurality of transactions, wherein the plurality of transactions are conducted at a plurality of different merchants by a plurality of different customer entities using a plurality of presentation instruments issued by the plurality of different issuers, wherein the transaction processing system is operated by the third party;
generating, by one or more of the processors, electronic receipts for the plurality of transactions from the transaction data received at the transaction processing system, wherein each of the electronic receipts provides evidence of a transaction between a merchant and a customer entity, and wherein each of the electronic receipts comprises data reflecting at least the identity of a merchant, the presentation instrument used in making a transaction, the date of a transaction, and the amount of a transaction;
storing, by one or more of the processors, the electronic receipts at a receipt database;
providing, by one or more of the processors, access to the stored electronic receipts to both customer entities and the merchants;
in response to receiving the transaction data at the transaction processing system from one of the POS devices for one of the transactions, determining at the transaction processing system for that transaction (1) whether there is a customer preference regarding the transmission of a transaction notification at the time of a transaction in lieu of a paper receipt, and (2) whether there is a customer preference for printing of a receipt when a transaction is above a specified amount;
transmitting, by one or more of the processors, a transaction response message from the transaction processing system to the one of the POS devices, the transaction response message having a data field for including (1) an “approved—do not print receipt” data code when there is a customer preference for an electronic notification to be transmitted at the time of a transaction in lieu of a paper receipt, and when the amount of the transaction is not above the specified amount, and (2) an “approved—print receipt” data code when there is a customer preference for an electronic notification to be transmitted at the time of a transaction in lieu of a paper receipt, and when the amount of the transaction is above the specified amount; and
in response to the “approved—do not print receipt” data code, suppressing, at the one of the POS devices, the printing of a paper receipt.

2. The method of claim 1, wherein the third party entity is a third party transaction processing entity that operates the transaction processing system.

3. The method of claim 1, wherein the merchants enroll in a merchant program for obtaining access to electronic receipts with a third party transaction processing entity that operates the transaction processing system.

4. The method of claim 1, wherein the preference data is provided by each of the customer entities during enrollment and includes at least one of a mobile device ID or an email address for receiving the transaction notification.

5. The method of claim 1, wherein the transaction notification is in the form of a short message service (SMS) message and is transmitted to a mobile device of a customer entity, the SMS message having a portion of the data from an electronic receipt.

6. The method of claim 5, wherein the transaction notification includes a link for accessing a website having a complete electronic receipt.

7. The method of claim 1, wherein the stored electronic receipts are accessible by the customer entities and the merchants through a website maintained by a transaction processing entity.

8. (canceled)

9. The method of claim 1, wherein customer entities enroll in the customer program at an issuer of a presentation instrument, wherein the issuer provides the preference data to the third party entity, and wherein the third party entity is a third party transaction processing entity that operates the transaction processing system.

10. The method of claim 1, wherein the merchants enroll in a merchant program for obtaining access to electronic receipts with a third party transaction processing entity that operates the card transaction processing system.

11. The method of claim 1, wherein the presentation instruments are each associated with a credit card account.

12. The method of claim 1, wherein the presentation instruments are each a card.

13. The method of claim 1, wherein the electronic receipts include promotional information when accessed by a customer entity.

14. The method of claim 13, wherein the promotional information may be selectively removed from the electronic receipts when accessed by a merchant.

15. The method of claim 13, further comprising:
analyzing, at the transaction processing system, the transaction data to determine customer spending trends; and
developing the promotional information based on the determined customer spending trends.

16. The method of claim 15, wherein the merchants include a first merchant having a first merchant classification and a second merchant having a second merchant classification, wherein the step of analyzing the transaction data includes determining a likelihood of the customer entity conducting a transaction with the second merchant after the first merchant, and wherein the developed promotional information is associated with the merchant classification of the second merchant.

17. A method for managing receipts for transactions conducted by a customer entity at a merchant using a presentation instrument, the method comprising:
receiving, at a transaction processing system from a plurality of point-of-sale (POS) devices, transaction data for each of a plurality of transactions conducted at a plurality of merchants by a plurality of different customer entities using presentation instruments issued by a plurality of issuers, the transaction data including merchant classification data for the merchants at which the transactions are conducted;
generating, at the transaction processing system and at the time of each of the transactions, a transaction notification for each of the transactions based on the transaction data;
aggregating transaction data for the plurality of transactions conducted at the plurality of merchants by the plurality of different customer entities;
analyzing, at the transaction processing system, the aggregated transaction data for the plurality of transactions to determine a likelihood of a customer entity conducting, after a first transaction with a first merchant having a first merchant classification, a second, subsequent transaction with a second merchant having a second merchant classification;
developing, by one or more processors, the promotional information based on the second merchant classification of the second merchant;
associating, by one or more of the processors, the promotional information with the transaction notification generated for the first transaction; and
transmitting, by one or more of the processors, the transaction notification to the customer entity, wherein the promotional information is transmitted with the transaction notification at the time of the first transaction with the first merchant.

18. (canceled)

19. The method of claims 18, further comprising:
generating electronic receipts from the transaction data transmitted to the transaction processing system; and
storing the electronic receipts at a receipt database.

20. The method of claim 19, wherein the transaction notification is in the form of a standard message service (SMS) message and is transmitted to a mobile device of a customer entity, the SMS message having a portion of the data from an electronic receipt.

21. The method of claim 19, wherein the transaction notification includes a link for accessing a website having a complete electronic receipt.

22. The method of claim 19, wherein the stored electronic receipts are accessible by the customer entity through a website maintained by a transaction processing entity.

23. The method of claim 19, wherein the transaction processing system is operated by a third party transaction processing entity that is not a merchant and not an issuer of the presentation instruments.

24. The method of claim 19, wherein the transaction processing system is operated by a third party transaction processing entity that processes transactions between the merchants and the customer entities.

25. The method of claim 19, wherein the transaction processing system is operated by a third party transaction processing entity that processes transactions between the merchants and the customer entities, wherein the electronic receipts provide evidence of transactions between the merchants and the customer entities, and wherein the electronic receipts each comprise data reflecting at least the identity of a merchant, the date of a transaction, and the amount of a transaction.

26. A method for managing receipts for transactions conducted by customer entities at merchants using presentation instruments, the method comprising:
enrolling, by one or more processors, the customer entities in a customer program for receiving electronic receipts in lieu of paper receipts for transactions conducted by customer entities at merchants using the presentation instruments, wherein the presentation instruments are issued by a plurality of issuers, wherein enrollment is managed by a third party that is not a merchant and not an issuer of the presentation instruments, wherein enrollment includes storing, in a preference database managed by the third party, preference data from each of the customer entities, wherein the preference data for each of the customer entities represents at least one customer preference regarding the transmission of a transaction notification at the time of a transaction in lieu of a paper receipt, and wherein the preference data for at least one or more of the customer entities further represents a preference for printing of a receipt when a transaction is above a specified amount;
capturing, with a point-of-sale (POS) device, transaction data for each of the transactions;
transmitting, by one or more of the processors, the transaction data to a transaction processing system;
in response to transmitting the transaction data to the transaction processing system, determining at the transaction processing system for each transaction (1) whether there is a customer preference regarding the transmission of a transaction notification at the time of a transaction in lieu of a paper receipt, and (2) whether there is a customer preference for printing of a receipt when a transaction is above a specified amount;
transmitting, by one or more of the processors, a transaction response message from the transaction processing system to the POS device, the transaction response message having a data field for including (1) an “approved—do not print receipt” data code when there is a customer preference for an electronic notification to be transmitted at the time of a transaction in lieu of a paper receipt, and when the amount of the transaction is not above the specified amount, and (2) an “approved—print receipt” data code when there is a customer preference for an electronic notification to be transmitted at the time of a transaction in lieu of a paper receipt, and when the amount of the transaction is above the specified amount; and
in response to the “approved—do not print receipt” data code, suppressing, at the POS device, the printing of a paper receipt.

27. The method of claim 26, wherein the preference data establishes that electronic receipts are to be provided in lieu of paper receipts unless the transaction data reflects a specified condition relating to the transaction.

28. The method of claim 27, wherein the specified condition relates to whether the amount of the transaction is below a pre-determined threshold.

29. The method of claim 26, wherein the transaction data for each of the transactions includes data identifying the customer entity, wherein the data identifying the customer entity is data identifying an account with which the customer entity is associated.

30. A system for managing electronic receipts for transactions conducted by customers at merchants using presentation instruments, the system comprising:
a preference database for storing preference data from each of the customers, wherein the preference data is received during enrollment in a customer program under which a customer receives electronic receipts in lieu of paper receipts for transactions conducted at merchants by that customer, wherein the preference data represents at least one customer preference regarding the transmission of a transaction notification at the time of a transaction by that customer in lieu of a paper receipt, and wherein the preference data for at least one or more of the enrolled customer entities further represents a preference for printing of a receipt when a transaction is above a specified amount, wherein the enrollment is managed by a third party that is not a merchant and not an issuer of the presentation instruments, and wherein the transaction is conducted at any one of a plurality of different merchants by any one of a plurality of different customers using any one of a plurality of different presentation instruments issued by any one of a plurality of different issuers;
point-of-sale (POS) devices at the merchants for capturing transaction data for each of the transactions;
a transaction processing system operated by the third party for receiving the transaction data captured at the POS devices and generating electronic receipts from the transaction data transmitted to the transaction processing system;
a receipt database for a storing the electronic receipts and providing access to the stored electronic receipts to both the customers and the merchants;
wherein, in response to receiving the transaction data at the transaction processing system captured at one of the POS devices, the transaction processing system determines for each transaction at that one of the POS devices (1) whether there is a customer preference regarding the transmission of a transaction notification at the time of a transaction in lieu of a paper receipt, and (2) whether there is a customer preference for printing of a receipt when a transaction is above a specified amount;
wherein the transaction processing system transmits a transaction response message to the one of the POS devices, the transaction response message having a data field for including (1) an “approved—do not print receipt” data code when there is a customer preference for an electronic notification to be transmitted at the time of a transaction in lieu of a paper receipt, and when the amount of the transaction is not above the specified amount, and (2) an “approved—print receipt” data code when there is a customer preference for an electronic notification to be transmitted at the time of a transaction in lieu of a paper receipt, and when the amount of the transaction is above the specified amount; and
in response to the “approved—do not print receipt” data code, suppressing, at the one of the POS devices, the printing of a paper receipt.
